(19) United States
(12) Patent Application Publication
(10) Pub. No.: US 2024/0411816 A1
(43) Pub. Date: Dec. 12, 2024

(54) INSTRUMENT AGNOSTIC TEMPLATE SYSTEM FOR DATA COLLECTION

(71) Applicant: DIONEX CORPORATION, SUNNYVALE, CA (US)

(72) Inventors: Sherif Elsaid, Sunnyvale, CA (US); Hung Q. Vu, Sunnyvale, CA (US)

(21) Appl. No.: 18/737,638

(22) Filed: Jun. 7, 2024

Related U.S. Application Data
(60) Provisional application No. 63/507,252, filed on Jun. 9, 2023.

(51) Int. Cl. G06F 16/903

(52) U.S. Cl. CPC G06F 16/90335

(57) ABSTRACT

Disclosed herein are scientific instrument support systems, as well as related methods, computing devices, and computer-readable media. For example, in some embodiments, a system for performing scientific instrument support is provided. The system, which may be implemented by a common computing device included a scientific instrument or remote from the scientific instrument or implemented by a plurality of computing devices included in the scientific instrument, remote from the scientific instrument, or a combination thereof, is configured to parse, with a data collector service, a template associated with a scientific instrument to extract a schema for the scientific instrument. The system is further configured to query, with the data collector service, the scientific instrument according to the schema. The system is further configured to receive data from the scientific instrument responsive to the query. An automated method performed via a computing device for providing such scientific instrument support is also provided.

### SUMMARY

The present application is related to and claims benefit under 35 U.S.C. § 119(e) from U.S. Provisional Patent Application Ser. No. 63/507,252, filed Jun. 9, 2023, entitled “Instrument Agnostic Template System for Data Collection,” the entire contents of which is incorporated herein by reference.

### SUMMARY

Laboratory systems used in the chemical, life sciences, and other industries may include scientific instruments to, for example, determine substance composition, concentration, purity, and the like. These scientific instruments may include a mass spectrometer, a gas chromatography device, or other suitable devices. Data from the scientific instruments is provided to instrument support systems, for example, a laboratory data system (e.g., the Chromeleon™ Chromatography Data System).

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, not by way of limitation, in the figures of the accompanying drawings.

FIG. 1 is a block diagram of an example scientific instrument support system, in accordance with various embodiments.

FIG. 2 is a block diagram of an example scientific instrument support system, in accordance with various embodiments.

FIG. 3 is a block diagram of an example scientific instrument support module for performing support operations, in accordance with various embodiments.

FIG. 4 is a block diagram of an example computing device that may perform some or all of the scientific instrument support operations disclosed herein, in accordance with various embodiments.

FIG. 5 is a block diagram of an example scientific instrument support system in which some or all of the scientific instrument support operations disclosed herein may be performed, in accordance with various embodiments.

FIG. 6 is a block diagram of an example system architecture in which some or all of the scientific instrument support operations disclosed herein may be performed, in accordance with various embodiments.

FIG. 7 is a flow diagram of an example method of performing scientific instrument support operations, in accordance with various embodiments.

### DETAILED DESCRIPTION

Disclosed herein are scientific instrument support systems, as well as related methods, computing devices, and computer-readable media. For example, in some embodiments, a system for performing scientific instrument support is provided. The system, which may be implemented by a common computing device included a scientific instrument or remote from the scientific instrument or implemented by a plurality of computing devices included in the scientific instrument, remote from the scientific instrument, or a combination thereof, is configured to parse, with a data collector service, a template associated with a scientific instrument to extract a schema for the scientific instrument. The system is further configured to query, with the data collector service, the scientific instrument according to the schema. The system is further configured to receive data from the scientific instrument responsive to the query. An automated method performed via a computing device for providing such scientific instrument support is also provided.

Data from the scientific instruments is provided to instrument support systems, for example, laboratory data systems. Each of the instruments can provide large amounts of valuable information, sometimes continuously. With movements toward “big data,” such information is used to build data lakes or to build and train machine learning models. As such, it is increasingly important to collect data from each scientific instrument and send it outside of the laboratory data system for further processing, e.g., to cloud-based back end services.

Collecting data is a crucial part of any machine learning workflow. Scientific instrument support systems may support and collect data from hundreds of scientific instruments with hundreds of possible configurations. Collecting results and other data from each of these instruments begins at the driver level and includes multiple levels of abstraction before reaching the cloud for processing. Each time a new instrument or driver is added to the system, the components of the data pipeline for the new system must be implemented from scratch. This process is tedious and inefficient.

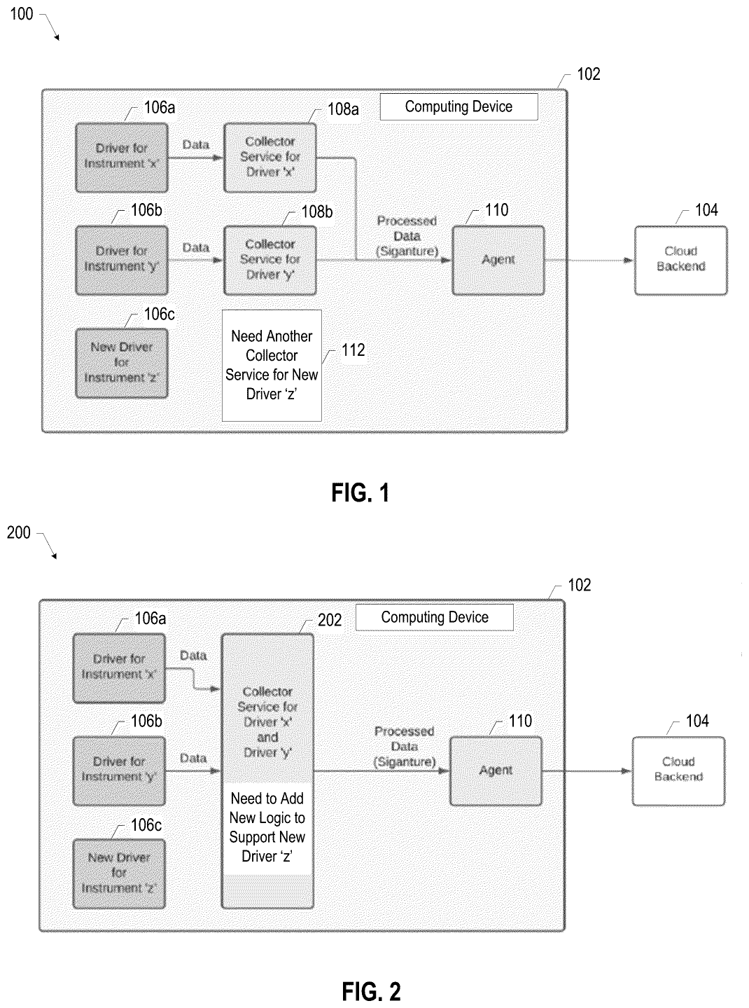

For example, FIG. 1 illustrates a scientific instrument support system 100. The system 100 includes a computing device 102 and a cloud backend 104. The computing device 102 collects data from scientific instruments using, for example, instrument drivers 106a-106c. In the configuration illustrated in FIG. 1, computing device 102 collects data from the scientific instruments using data collectors 108a, 108b. Each of the data collectors is custom programmed to interface with a single instrument driver, as shown in FIG. 1. The collectors 108a, 108b interface with the instrument drivers to collect particular data, process the data, and pass it to the data relay agent 110. The data relay agent interfaces with the cloud backend 104 (e.g., performing authentication and establishing connections between the computing device 102 and the cloud backend 104) to transmit the collected and processed data to the cloud backend 104. Using such configurations, when a new instrument is added, a new instrument driver (e.g., instrument driver 106c) is introduced, which requires the creation and addition of a new data collector 112. Furthermore, updating an instrument driver may require changing the associated data collector. For example, the data collector may have to be re-coded to reflect the changes to the driver (e.g., to accommodate changes in the driver interface, data formatting, and the like). Finally, if the cloud backend 104 is updated or replaced, or an additional cloud backend is added, this may require changing many instrument drivers and/or their associated collector services.

In another example, FIG. 2 illustrates a scientific instrument support system 200. The system 200 includes the computing device 102 and the cloud backend 104. The system 200 operates similarly to the system 100, except that it utilizes a single data collector 202, rather than multiple data collectors. In the configuration illustrated in FIG. 2, the single collector service is configured to interface with each instrument driver. Using the configuration of FIG. 2, when a new instrument is added, a new instrument driver (e.g., instrument driver 106c) is introduced, which requires the recoding of the data collector 202 to add support for the new instrument driver 106c. Similarly, updating an instrument driver require recoding the data collector. For example, the data collector may have to be re-coded to reflect the changes to the driver (e.g., to accommodate changes in the driver interface, data formatting, and the like). In addition, should the data collector 202 be changed, it may require the recoding of some or all of the instrument drivers.

In at least one instance, the data collectors and/or drivers disclosed herein are software components, tools, and/or systems. In at least one instance, the data collectors are software components for gathering, storing, and/or managing data, for example. In at least one instance, the drivers include software components for providing a communication and/or control interface between hardware and software (e.g., an operating system, the data collectors, and the like).

The scientific instrument support embodiments disclosed herein may achieve improved performance relative to these approaches. For example, adding new scientific instruments or changing their configurations may require adding new instrument drivers, recoding existing data collectors or both. In addition, new uses for laboratory data and new data pipelines for existing scientific instruments require driver developers to create a customized data collection service for each instrument or driver. This takes time and effort, reduces the uptime of instruments and systems, reducing their efficiency and significantly wasting resources, and may introduce bugs or other software-related problems into the scientific instrument support systems.

Accordingly, embodiments described herein improve on existing methods by introducing a single tool to replace the building and/or customization of individual pipelines for new instruments and drivers. Embodiments disclosed herein provide a flexible and extendable template system based on predefined schema. Using such embodiments, current and new instruments can collect and send data to the cloud using a single driver and an instrument agnostic data collector service. Using such embodiments, a template is provided for each instrument driver. The schema of the template is parsed by the data collector service to interpret what data should be collected under what conditions, and how such data should be packaged and reported. Using such embodiments, instrument drivers and the data collector service remain unaltered when new instruments are added to a laboratory system or changes are made to data pipelines. The data collector service is instrument agnostic. No extra logic or processing need be added to the data collector service to enable the addition of a new scientific instrument. Using embodiments described herein, the addition of a new instrument or a change in a data pipeline configuration is addressed by updating only the relevant templates.

The embodiments disclosed herein may reduce the time and effort conventionally taken when onboarding new instruments to a laboratory system and collecting operational and other data from scientific instruments and further may achieve improved speed, accuracy, and reliability relative to conventional approaches. These conventional approaches suffer from a number of technical problems and limitations, as noted above.

Various ones of the embodiments disclosed herein may improve upon conventional approaches to achieve the technical advantages of higher utilization of scientific instruments and improved efficiency of laboratory computing systems. Such technical advantages are not achievable by routine and conventional approaches, and all users of systems including such embodiments may benefit from these advantages (e.g., by assisting the user in the performance of a technical task, such as introducing a new scientific instrument to a laboratory system or connecting the laboratory system to cloud based machine learning systems). The technical features of the embodiments disclosed herein are thus decidedly unconventional in the field of support systems for scientific instruments, as are the combinations of the features of the embodiments disclosed herein. As discussed further herein, various aspects of the embodiments disclosed herein may improve the functionality of a computer itself; for example, improving the ability of the computer to interface with other machines (e.g., scientific instruments). The computational features disclosed herein do not only involve the collection and comparison of information but apply new analytical and technical techniques to change the operation of data processing workflow. The present disclosure thus introduces functionality that neither a conventional computing device, nor a human, could perform.

Accordingly, the embodiments of the present disclosure may serve any of a number of technical purposes, such as controlling a specific technical system or process. In particular, the present disclosure provides technical solutions to technical problems including, but not limited to, improved operation, more efficient configuration, and more robust data collection capabilities, which improves the speed and operation of scientific instruments. The embodiments disclosed herein thus provide improvements to scientific instrument support technology (e.g., improvements in the computer technology supporting scientific instruments, among other improvements).

In the following detailed description, reference is made to the accompanying drawings that form a part hereof wherein like numerals designate like parts throughout, and in which is shown, by way of illustration, embodiments that may be practiced. It is to be understood that other embodiments may be utilized, and structural or logical changes may be made, without departing from the scope of the present disclosure. Therefore, the following detailed description is not to be taken in a limiting sense.

Various operations may be described as multiple discrete actions or operations in turn, in a manner that is most helpful in understanding the subject matter disclosed herein. However, the order of description should not be construed as to imply that these operations are necessarily order dependent. In particular, these operations may not be performed in the order of presentation. Operations described may be performed in a different order from the described embodiment. Various additional operations may be performed, and/or described operations may be omitted in additional embodiments.

For the purposes of the present disclosure, the phrases “A and/or B” and “A or B” mean (A), (B), or (A and B). For the purposes of the present disclosure, the phrases “A, B, and/or C” and “A, B, or C” mean (A), (B), (C), (A and B), (A and C), (B and C), or (A, B, and C). Although some elements may be referred to in the singular (e.g., “a processing device”), any appropriate elements may be represented by multiple instances of that element, and vice versa. For example, a set of operations described as performed by a processing device may be implemented with different ones of the operations performed by different processing devices.

The description uses the phrases “an embodiment,” “various embodiments,” and “some embodiments,” each of which may refer to one or more of the same or different embodiments. Furthermore, the terms “comprising,” “including,” “having,” and the like, as used with respect to embodiments of the present disclosure, are synonymous. When used to describe a range of dimensions, the phrase “between X and Y” represents a range that includes X and Y. As used herein, an “apparatus” may refer to any individual device, collection of devices, part of a device, or collections of parts of devices. The drawings are not necessarily to scale.

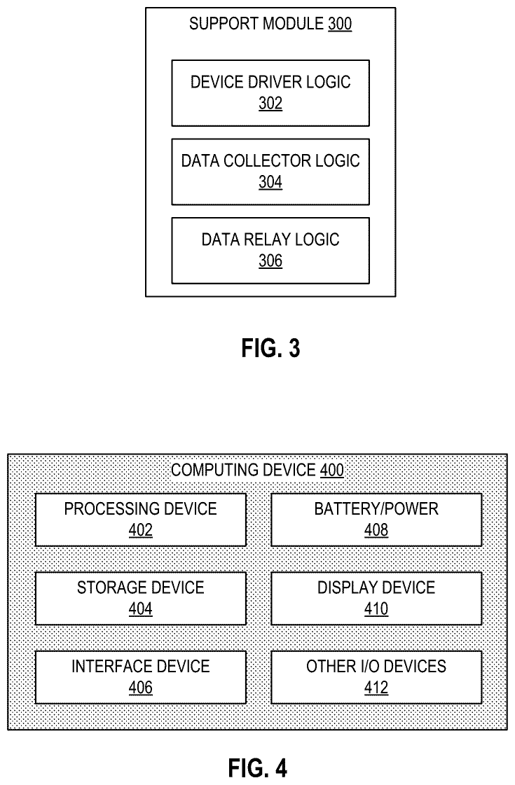

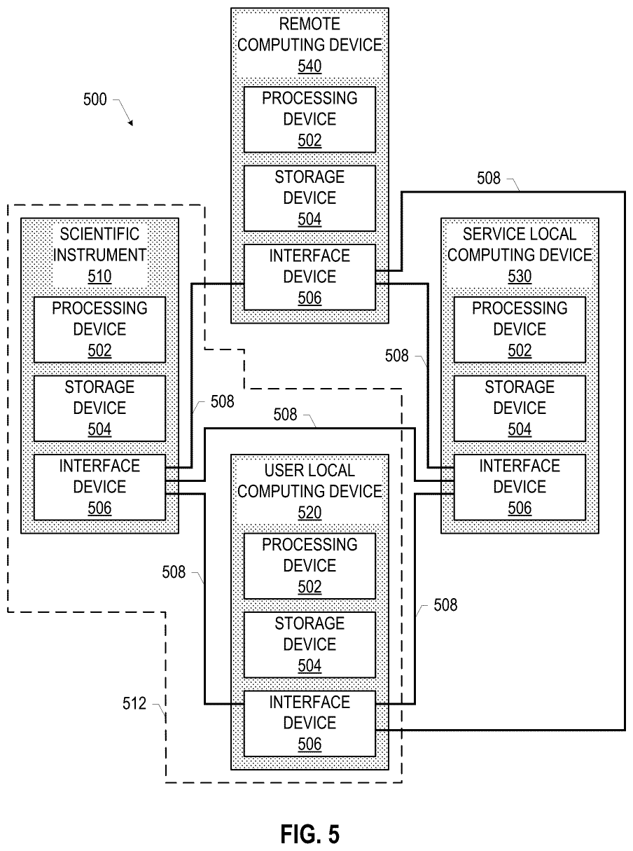

FIG. 3 is a block diagram of a scientific instrument support module 300 for performing support operations, in accordance with various embodiments. The scientific instrument support module 300 may be implemented by circuitry (e.g., including electrical and/or optical components), such as a programmed computing device. The logic of the scientific instrument support module 300 may be included in a single computing device or may be distributed across multiple computing devices that are in communication with each other as appropriate. Examples of computing devices that may, singly or in combination, implement the scientific instrument support module 300 are discussed herein with reference to the computing device 400 of FIG. 4, and examples of systems of interconnected computing devices, in which the scientific instrument support module 300 may be implemented across one or more of the computing devices, is discussed herein with reference to the scientific instrument support system 500 of FIG. 5.

The scientific instrument support module 300 may include an instrument driver logic 302, a data collector logic 304, and a data rely logic 306. As used herein, the term “logic” may include an apparatus that is to perform a set of operations associated with the logic. For example, any of the logic elements included in the support module 300 may be implemented by one or more computing devices programmed with instructions to cause one or more processing devices of the computing devices to perform the associated set of operations. In a particular embodiment, a logic element may include one or more non-transitory computer-readable media having instructions thereon that, when executed by one or more processing devices of one or more computing devices, cause the one or more computing devices to perform the associated set of operations. As used herein, the term “module” may refer to a collection of one or more logic elements that, together, perform a function associated with the module. Different ones of the logic elements in a module may take the same form or may take different forms. For example, some logic in a module may be implemented by a programmed general-purpose processing device, while other logic in a module may be implemented by an application-specific integrated circuit (ASIC). In another example, different ones of the logic elements in a module may be associated with different sets of instructions executed by one or more processing devices. A module may not include all of the logic elements depicted in the associated drawing; for example, a module may include a subset of the logic elements depicted in the associated drawing when that module is to perform a subset of the operations discussed herein with reference to that module.

The instrument driver logic 302 provides a software abstraction layer that allows the scientific instrument support module 300 to interface with one or more scientific instruments. In some aspects, the instrument driver logic 302 includes multiple instrument drivers, each one associated with a different scientific instrument. Using the instrument driver logic 302, the scientific instrument support module 300 communicates with scientific instruments to, among other things, collect data, as described herein.

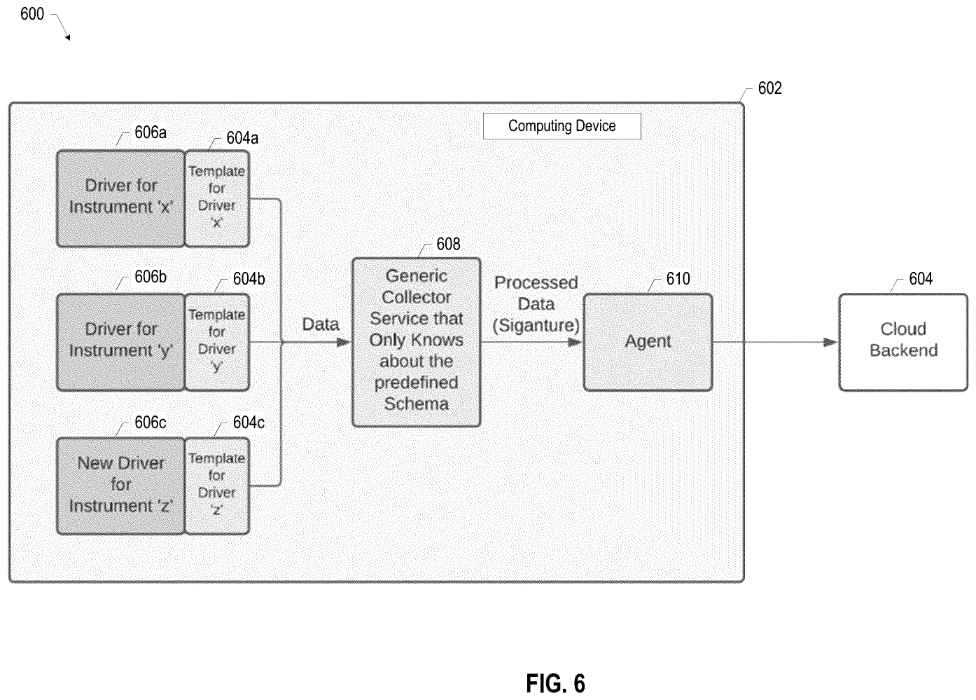

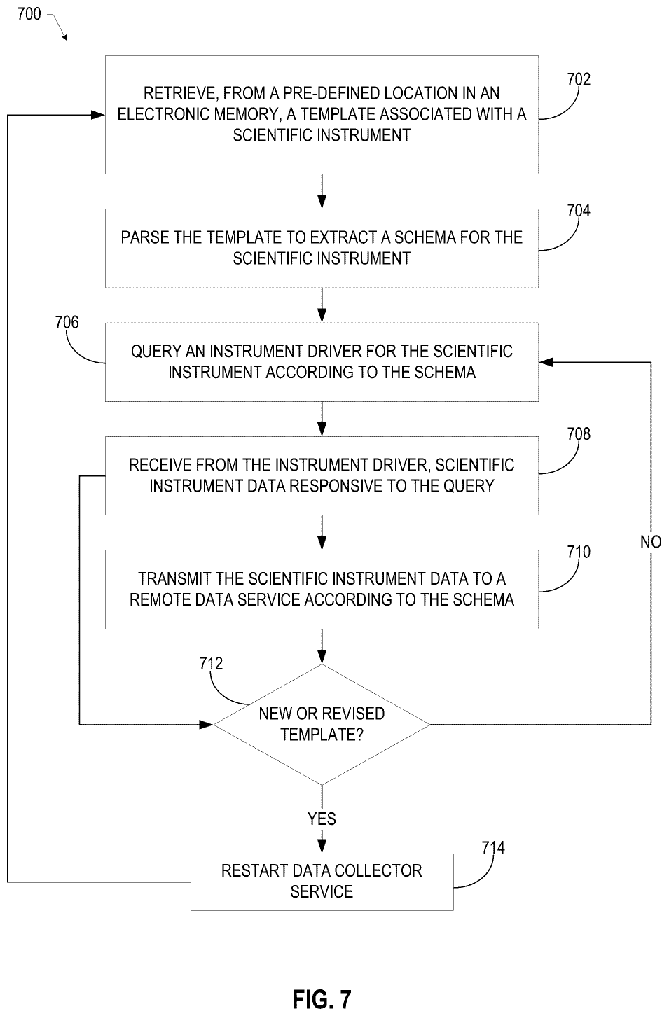

The data collector logic 304 interfaces with the instrument driver logic 302 to collect data from scientific instruments, as described herein with respect to FIGS. 6 and 7. In some aspects, the data collector logic 304 processes the collected data (e.g., by standardizing the data, aggregating the data, anonymizing the data, contextualizing the data, or combinations of the foregoing). In some aspects, the data collector logic 304 interfaces with the data relay logic 306 to transmit processed data, raw data, or both to outside services such as, for example, cloud based machine learning engines, data lakes, and the like.

The data relay logic 306 transmits data from the scientific instrument support module 300 to outside services. For example, the data relay logic may authenticate to and make a secure connection with a machine learning engine to transmit processed data from the scientific instruments.

As noted above, the scientific instrument support module 300 may be implemented by one or more computing devices. FIG. 4 is a block diagram of a computing device 400 that may perform some or all of the scientific instrument support methods disclosed herein, in accordance with various embodiments. In some embodiments, the scientific instrument support module 300 may be implemented by a single computing device 400 or by multiple computing devices 400. Further, as discussed below, a computing device 400 (or multiple computing devices 400) that implements the scientific instrument support module 300 may be part of one or more of the scientific instrument 510, the user local computing device 520, the service local computing device 530, or the remote computing device 540 of FIG. 5.

The computing device 400 of FIG. 4 is illustrated as having a number of components, but any one or more of these components may be omitted or duplicated, as suitable for the application and setting. In some embodiments, some or all of the components included in the computing device 400 may be attached to one or more motherboards and enclosed in a housing (e.g., including plastic, metal, and/or other materials). In some embodiments, some these components may be fabricated onto a single system-on-a-chip (SoC) (e.g., an SoC may include one or more processing devices 402 and one or more storage devices 404). Additionally, in various embodiments, the computing device 400 may not include one or more of the components illustrated in FIG. 4, but may include interface circuitry (not shown) for coupling to the one or more components using any suitable interface (e.g., a Universal Serial Bus (USB) interface, a High-Definition Multimedia Interface (HDMI) interface, a Controller Area Network (CAN) interface, a Serial Peripheral Interface (SPI) interface, an Ethernet interface, a wireless interface, or any other appropriate interface). For example, the computing device 400 may not include a display device 410, but may include display device interface circuitry (e.g., a connector and driver circuitry) to which a display device 410 may be coupled.

The computing device 400 may include a processing device 402 (e.g., one or more processing devices, an electronic processor, etc.). As used herein, the term “processing device” may refer to any device or portion of a device that processes electronic data from registers and/or memory to transform that electronic data into other electronic data that may be stored in registers and/or memory. The processing device 402 may include one or more digital signal processors (DSPs), application-specific integrated circuits (ASICs), central processing units (CPUs), graphics processing units (GPUs), cryptoprocessors (specialized processors that execute cryptographic algorithms within hardware), server processors, or any other suitable processing devices.

The computing device 400 may include a storage device 404 (e.g., one or more storage devices). The storage device 404 may include one or more memory devices such as random access memory (RAM) (e.g., static RAM (SRAM) devices, magnetic RAM (MRAM) devices, dynamic RAM (DRAM) devices, resistive RAM (RRAM) devices, or conductive-bridging RAM (CBRAM) devices), hard drive-based memory devices, solid-state memory devices, networked drives, cloud drives, or any combination of memory devices. In some embodiments, the storage device 404 may include memory that shares a die with a processing device 402. In such an embodiment, the memory may be used as cache memory and may include embedded dynamic random access memory (eDRAM) or spin transfer torque magnetic random access memory (STT-MRAM), for example. In some embodiments, the storage device 404 may include non-transitory computer readable media having instructions thereon that, when executed by one or more processing devices (e.g., the processing device 402), cause the computing device 400 to perform any appropriate ones of or portions of the methods disclosed herein.

The computing device 400 may include an interface device 406 (e.g., one or more interface devices 406). The interface device 406 may include one or more communication chips, connectors, and/or other hardware and software to govern communications between the computing device 400 and other computing devices. For example, the interface device 406 may include circuitry for managing wireless communications for the transfer of data to and from the computing device 400. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not. Circuitry included in the interface device 406 for managing wireless communications may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra mobile broadband (UMB) project (also referred to as “3GPP2”), etc.). In some embodiments, circuitry included in the interface device 406 for managing wireless communications may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. In some embodiments, circuitry included in the interface device 406 for managing wireless communications may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). In some embodiments, circuitry included in the interface device 406 for managing wireless communications may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. In some embodiments, the interface device 406 may include one or more antennas (e.g., one or more antenna arrays) to receipt and/or transmission of wireless communications.

In some embodiments, the interface device 406 may include circuitry for managing wired communications, such as electrical, optical, or any other suitable communication protocols. For example, the interface device 406 may include circuitry to support communications in accordance with Ethernet technologies. In some embodiments, the interface device 406 may support both wireless and wired communication, and/or may support multiple wired communication protocols and/or multiple wireless communication protocols. For example, a first set of circuitry of the interface device 406 may be dedicated to shorter-range wireless communications such as Wi-Fi or Bluetooth, and a second set of circuitry of the interface device 406 may be dedicated to longer-range wireless communications such as global positioning system (GPS), EDGE, GPRS, CDMA, WiMAX, LTE, EV-DO, or others. In some embodiments, a first set of circuitry of the interface device 406 may be dedicated to wireless communications, and a second set of circuitry of the interface device 406 may be dedicated to wired communications.

The computing device 400 may include battery/power circuitry 408. The battery/power circuitry 408 may include one or more energy storage devices (e.g., batteries or capacitors) and/or circuitry for coupling components of the computing device 400 to an energy source separate from the computing device 400 (e.g., AC line power).

The computing device 400 may include a display device 410 (e.g., multiple display devices). The display device 410 may include any visual indicators, such as a heads-up display, a computer monitor, a projector, a touchscreen display, a liquid crystal display (LCD), a light-emitting diode display, or a flat panel display.

The computing device 400 may include other input/output (1/O) devices 412. The other I/O devices 412 may include one or more audio output devices (e.g., speakers, headsets, earbuds, alarms, etc.), one or more audio input devices (e.g., microphones or microphone arrays), location devices (e.g., GPS devices in communication with a satellite-based system to receive a location of the computing device 400, as known in the art), audio codecs, video codecs, printers, sensors (e.g., thermocouples or other temperature sensors, humidity sensors, pressure sensors, vibration sensors, accelerometers, gyroscopes, etc.), image capture devices such as cameras, keyboards, cursor control devices such as a mouse, a stylus, a trackball, or a touchpad, bar code readers, Quick Response (QR) code readers, or radio frequency identification (RFID) readers, for example.

The computing device 400 may have any suitable form factor for its application and setting, such as a handheld or mobile computing device (e.g., a cell phone, a smart phone, a mobile internet device, a tablet computer, a laptop computer, a netbook computer, an ultrabook computer, a personal digital assistant (PDA), an ultra mobile personal computer, etc.), a desktop computing device, or a server computing device or other networked computing component.

One or more computing devices implementing any of the scientific instrument support modules or methods disclosed herein may be part of a scientific instrument support system. FIG. 5 is a block diagram of an example scientific instrument support system 500 in which some or all of the scientific instrument support methods disclosed herein may be performed, in accordance with various embodiments. The scientific instrument support modules and methods disclosed herein (e.g., the scientific instrument support module 300 of FIG. 3 and the method 700 of FIG. 7) may be implemented by one or more of the scientific instrument 510, the user local computing device 520, the service local computing device 530, or the remote computing device 540 of the scientific instrument support system 500.

Any of the scientific instrument 510, the user local computing device 520, the service local computing device 530, or the remote computing device 540 may include any of the embodiments of the computing device 400 discussed herein with reference to FIG. 4, and any of the scientific instrument 510, the user local computing device 520, the service local computing device 530, or the remote computing device 540 may take the form of any appropriate ones of the embodiments of the computing device 400 discussed herein with reference to FIG. 4.

The scientific instrument 510, the user local computing device 520, the service local computing device 530, or the remote computing device 540 may each include a processing device 502, a storage device 504, and an interface device 506. The processing device 502 may take any suitable form, including the form of any of the processing devices 402 discussed herein with reference to FIG. 4, and the processing devices 502 included in different ones of the scientific instrument 510, the user local computing device 520, the service local computing device 530, or the remote computing device 540 may take the same form or different forms. The storage device 504 may take any suitable form, including the form of any of the storage devices 504 discussed herein with reference to FIG. 4, and the storage devices 504 included in different ones of the scientific instrument 510, the user local computing device 520, the service local computing device 530, or the remote computing device 540 may take the same form or different forms. The interface device 506 may take any suitable form, including the form of any of the interface devices 406 discussed herein with reference to FIG. 4, and the interface devices 506 included in different ones of the scientific instrument 510, the user local computing device 520, the service local computing device 530, or the remote computing device 540 may take the same form or different forms.

The scientific instrument 510, the user local computing device 520, the service local computing device 530, and the remote computing device 540 may be in communication with other elements of the scientific instrument support system 500 via communication pathways 508. The communication pathways 508 may communicatively couple the interface devices 506 of different ones of the elements of the scientific instrument support system 500, as shown, and may be wired or wireless communication pathways (e.g., in accordance with any of the communication techniques discussed herein with reference to the interface devices 406 of the computing device 400 of FIG. 4). The particular scientific instrument support system 500 depicted in FIG. 5 includes communication pathways between each pair of the scientific instrument 510, the user local computing device 520, the service local computing device 530, and the remote computing device 540, but this “fully connected” implementation is simply illustrative, and in various embodiments, various ones of the communication pathways 508 may be absent. For example, in some embodiments, a service local computing device 530 may not have a direct communication pathway 508 between its interface device 506 and the interface device 506 of the scientific instrument 510, but may instead communicate with the scientific instrument 510 via the communication pathway 508 between the service local computing device 530 and the user local computing device 520 and the communication pathway 508 between the user local computing device 520 and the scientific instrument 510.

The user local computing device 520 may be a computing device (e.g., in accordance with any of the embodiments of the computing device 400 discussed herein) that is local to a user of the scientific instrument 510. In some embodiments, the user local computing device 520 may also be local to the scientific instrument 510, but this need not be the case; for example, a user local computing device 520 that is in a user's home or office may be remote from, but in communication with, the scientific instrument 510 so that the user may use the user local computing device 520 to control and/or access data from the scientific instrument 510. In some embodiments, the user local computing device 520 may be a laptop, smartphone, or tablet device. In some embodiments the user local computing device 520 may be a portable computing device. In some embodiments, the user local computing device 520 may locally perform the method 700 of FIG. 7.

The service local computing device 530 may be a computing device (e.g., in accordance with any of the embodiments of the computing device 400 discussed herein) that is local to an entity that services the scientific instrument 510. For example, the service local computing device 530 may be local to a manufacturer of the scientific instrument 510 or to a third-party service company. In some embodiments, the service local computing device 530 may communicate with the scientific instrument 510, the user local computing device 520, and/or the remote computing device 540 (e.g., via a direct communication pathway 508 or via multiple “indirect” communication pathways 508, as discussed above) to receive data regarding the operation of the scientific instrument 510, the user local computing device 520, and/or the remote computing device 540 (e.g., the results of self-tests of the scientific instrument 510, calibration coefficients used by the scientific instrument 510, the measurements of sensors associated with the scientific instrument 510, etc.). In some embodiments, the service local computing device 530 may communicate with the scientific instrument 510, the user local computing device 520, and/or the remote computing device 540 (e.g., via a direct communication pathway 508 or via multiple “indirect” communication pathways 508, as discussed above) to transmit data to the scientific instrument 510, the user local computing device 520, and/or the remote computing device 540 (e.g., to update programmed instructions, such as firmware, in the scientific instrument 510, to initiate the performance of test or calibration sequences in the scientific instrument 510, to update programmed instructions, such as software, in the user local computing device 520 or the remote computing device 540, etc.). A user of the scientific instrument 510 may utilize the scientific instrument 510 or the user local computing device 520 to communicate with the service local computing device 530 to report a problem with the scientific instrument 510 or the user local computing device 520, to request a visit from a technician to improve the operation of the scientific instrument 510, to order consumables or replacement parts associated with the scientific instrument 510, or for other purposes.

The remote computing device 540 may be a computing device (e.g., in accordance with any of the embodiments of the computing device 400 discussed herein) that is remote from the scientific instrument 510 and/or from the user local computing device 520. In some embodiments, the remote computing device 540 may be included in a datacenter or other large-scale server environment. In some embodiments, the remote computing device 540 may include network-attached storage (e.g., as part of the storage device 504). The remote computing device 540 may store data generated by the scientific instrument 510, perform analyses of the data generated by the scientific instrument 510 (e.g., in accordance with programmed instructions), facilitate communication between the user local computing device 520 and the scientific instrument 510, and/or facilitate communication between the service local computing device 530 and the scientific instrument 510.

In some embodiments, one or more of the elements of the scientific instrument support system 500 illustrated in FIG. 5 may not be present. Further, in some embodiments, multiple ones of various ones of the elements of the scientific instrument support system 500 of FIG. 5 may be present. For example, a scientific instrument support system 500 may include multiple user local computing devices 520 (e.g., different user local computing devices 520 associated with different users or in different locations). In another example, a scientific instrument support system 500 may include multiple scientific instruments 510, all in communication with service local computing device 530 and/or a remote computing device 540; in such an embodiment, the service local computing device 530 may monitor these multiple scientific instruments 510, and the service local computing device 530 may cause updates or other information may be “broadcast” to multiple scientific instruments 510 at the same time. Different ones of the scientific instruments 510 in a scientific instrument support system 500 may be located close to one another (e.g., in the same room) or farther from one another (e.g., on different floors of a building, in different buildings, in different cities, etc.). In some embodiments, a scientific instrument 510 may be connected to an Internet-of-Things (IoT) stack that allows for command and control of the scientific instrument 510 through a web-based application, a virtual or augmented reality application, a mobile application, and/or a desktop application. Any of these applications may be accessed by a user operating the user local computing device 520 in communication with the scientific instrument 510 by the intervening remote computing device 540. In some embodiments, a scientific instrument 510 may be sold by the manufacturer along with one or more associated user local computing devices 520 as part of a local scientific instrument computing unit 512.

In some embodiments, different ones of the scientific instruments 510 included in a scientific instrument support system 500 may be different types of scientific instruments 510; for example, one scientific instrument 510 may be a mass spectrometer, while another scientific instrument 510 may be a gas chromatography device. In some such embodiments, the remote computing device 540 and/or the user local computing device 520 may combine data from different types of scientific instruments 510 included in a scientific instrument support system 500.

FIG. 6 is a block diagram of a system architecture 600. The system architecture 600 may be implemented across the devices of the scientific instrument support system 500.

The system architecture 600 includes a computing device 602 and a cloud backend 604. In some embodiments, the computing device 602 may be on one or more computing devices, such as the user local computing device 520, the service local computing device 530 and/or a remote computing device 540. The cloud backend 604 is a remote computing platform, which is configured to receive scientific instrument data from the computing device 602.

The computing device 602 includes a plurality of templates 604a-604c, which are each associated with one of a plurality of instrument drivers 606a-606c. Each of the instrument drivers 606a-606c is associated with a different scientific instrument, and provides communication between the computing device 602 and its associated scientific instrument. The communication is effected by the data collector service 608. Although FIG. 6 illustrates only three instrument driver/template pairs, it should be understood that embodiments described herein may be applied to systems including hundreds or thousands of scientific instruments.

To communicate with and receive data from a scientific instrument, the data collector service 608 operates according to the template for that scientific instrument. In some aspects, the template is stored in an electronic memory of the computing device 602. In some aspects, the template is stored in an electronic memory external to and accessible by the computing device 602 (e.g., and electronic database). In some embodiments, the template is a digital file, which stores schema using the JavaScript Object Notation (JSON) format. The template acts as a contract between the data collector service 608 and any instrument and/or instrument driver that is part of the data collection process. The data collector service 608 retrieves a template, loads the schema, and interprets the schema in a declarative manner. In some aspects the templates are stored in pre-defined locations in the electronic memory. For example, the electronic memory of the computing device 602 may have reserved locations for the storage of templates. In another example, templates and their pre-defined locations may be accessed from a remote memory or database using lookup tables or another means. In some aspects, the data collector service 608 learns of the addition, deletion, or update of templates by checking the pre-determined location.

The template's schema defines what data is to be collected, under what circumstances it is to be collected, for how long it is to be collection, as well as other customizations and filters to control how the data is collected and sent to the cloud backend 604. In some embodiments, the data collector service 608 executes the data collector logic 304, operating as described herein to process data collected.

The relay agent 610 executes the data relay logic 306 and operates similarly to the relay agent 110 described above.

FIG. 7 is a flow diagram of a method 700 of performing support operations, in accordance with various embodiments. Although the operations of the method 700 may be illustrated with reference to particular embodiments disclosed herein (e.g., the scientific instrument support module 300 discussed herein with reference to FIG. 3, the computing device 400 discussed herein with reference to FIG. 4, the scientific instrument support system 500 discussed herein with reference to FIG. 5, and/or the system architecture 600 discussed herein with reference to FIG. 6), the method 700 may be used in any suitable setting to perform any suitable support operations. Operations are illustrated once each and in a particular order in FIG. 7, but the operations may be reordered and/or repeated as desired and appropriate (e.g., different operations performed may be performed in parallel, as suitable). By way of example, operations of the method 700 may be described as being performed by one of the instrument driver logic 302, data collector logic 304, or data rely logic 306 of the scientific instrument support module 300. However, it should be understood that the operations may be distributed in various ways among any number of logics or processing devices, including the various electronic processors described herein.

At block 702, the method includes retrieving, with a data collector service from a pre-defined location in an electronic memory, a template associated with a scientific instrument. For example, the data collector logic 304 of the support module 300 or the data collector service 608 (see FIG. 6) may perform the operations of 702. In one example, the data collector service 608 periodically checks a pre-defined location of an electronic memory for the presence of a template (e.g., an electronic file or other collection of schema stored electronically). In some aspects, the data collector service 608 checks a series of predefined memory locations for a template or templates. In other aspects, the data collector service 608 reads a list of active templates and their corresponding locations (e.g., a database, lookup table, or another suitable data structure) to determine how to retrieve a template or templates.

At block 704, the method includes parsing, with the data collector service, the template to extract a schema for the scientific instrument. For example, the data collector logic 304 of the support module 300 or the data collector service 608 (see FIG. 6) may perform the operations of 704. In one example, the data collector service 608 parses the template by interpreting the schema in a declarative manner to extract a series of rules for the scientific instrument associated with the template. The rules define what data should be collected under what conditions, and how such data should be packaged and reported. For example, the schema may define, for the associated scientific instrument, one or more of a data type, a data collection condition, a data collection schedule, a data filter, a data processing directive, and a data transmission schedule. For example, one rule of the schema may include a data type and a data collection schedule instructing the data collector service 608 to collect temperature data for the scientific instrument every hour for the next thirty days. In another example, a rule may include a data filter instructing the data collector service 608 to include only temperature data that falls outside of an expected range. In another example, a rule may include a data collection condition instructing the data collector service 608 to collect a particular data type only under certain conditions (e.g., a particular code has been received from the instrument, one or more other instruments are providing data of a particular type or value, and the like). In another example, a rule may include a data processing directive instructing the data collector service 608 to process a particular data type in a particular way (e.g., to bin the data, provide a rolling average for the data, anonymize the data, and the like).

At block 706, the method includes querying, with the data collector service, an instrument driver for the scientific instrument according to the schema. For example, the data collector logic 304 of the support module 300 or the data collector service 608 (see FIG. 6) may perform the operations of 706. In one example, the data collector service 608 accesses the instrument driver to retrieve data based on the rules in the schema.

At block 708, the method includes receiving, from the instrument driver, scientific instrument data responsive to the query. For example, the data collector logic 304 of the support module 300 or the data collector service 608 (see FIG. 6) may perform the operations of 708. In one example, the data collector service 608 receives data from the instrument driver and stores it in an electronic memory for processing and/or transmission.

At block 710, the method includes transmitting the scientific instrument data to a remote data service according to the schema. For example, the data relay logic 306 of the support module 300 or the data relay agent 610 (see FIG. 6) may perform the operations of 710. For example, the data relay agent 610 may establish an authenticated (e.g., secure) connection with the cloud backend 604 and transmit raw and/or processed data to the could backend 604. In some aspects, data is transmitted to multiple remote data services. In some aspects, the data is transmitted as files. In some aspects, the data is transmitted by making transactions to a remote database at the could backend 604. In some aspects, combinations of both may be used. In some aspects, data may be transmitted as it is received, on a continuous basis. In some aspects, the data relay agent 610 transmits data based on a rule or rules present in the schema. In some aspects, when, how, and where data for a particular scientific instrument is transmitted is defined in the template associated with that scientific instrument.

At block 712, the method includes identifying, in an electronic memory, one or both of a new (second) template associated with a new (second) scientific instrument or a revised template associated with the scientific instrument (e.g., a revised version of the template retrieved in block 702). For example, the data collector logic 304 of the support module 300 or the data collector service 608 (see FIG. 6) may perform the operations of 712. For example, the data collector service 608 may check for the presence of new or revised templates in an electronic memory, as described above with respect to block 702. In some aspects, a list of active templates and their corresponding locations includes an indicator (e.g., a flag or other suitable data value), which alerts the data collector service 608 that an already active template has been revised (e.g., updated with new schema).

As illustrated in FIG. 7, in some embodiments, the data collector service 608 checks for the presence of new or revised templates after receiving data (at block 708) or transmitting data (at block 710). In some embodiments, the data collector service 608 checks for the presence of new or revised templates periodically, without regard to what other operations of the method 700 are being performed.

At block 714, the method includes restarting the data collector service responsive to identifying the revised template. For example, the data collector service 608 may, upon detecting the new or revised template, may restart itself and retrieve and act upon templates, as described above with respect to blocks 702-710. In this way, new scientific instruments may be added to a laboratory system, or new data collection flows may be added for existing scientific instruments, without the need to re-code either the instrument drivers or the data collector service 608.

The following paragraphs provide various examples of the embodiments disclosed herein.

Example 1 is a system for performing scientific instrument support. The system comprises an electronic computing device including an electronic processor. The electronic processor is configured to parse, with a data collector service, a template associated with a scientific instrument to extract a schema for the scientific instrument. The electronic processor is further configured to query, with the data collector service, the scientific instrument according to the schema. The electronic processor is further configured to receive data from the scientific instrument responsive to the query.

Example 2 may include the subject matter of Example 1, and may further specify that the electronic processor is configured to transmit, with a data relay agent, the data from the scientific instrument to a remote data service according to the schema.

Example 3 may include the subject matter of Example 2, and may further specify that the electronic processor is configured to process the data from the scientific instrument with the data collector service according to the schema to generate processed data. Example 3 may also further specify that transmitting the data from the scientific instrument to the remote data service includes transmitting the processed data.

Example 4 may include the subject matter of Example 3, and may further specify that processing the data includes at least one selected from a group consisting of standardizing the data, aggregating the data, anonymizing the data, and contextualizing the data.

Example 5 may include the subject matter of any of Examples 2-4 and may further specify that transmitting the data from the scientific instrument to the remote data service includes transmitting the data from the scientific instrument according to a schedule defined by the schema.

Example 6 may include the subject matter of any of Examples 1-5, and may further specify that the electronic processor is configured to identify, in an electronic memory, a second template associated with a second scientific instrument. The electronic processor is further configured to, responsive to identifying the second template, restart the data collector service. The electronic processor is further configured to parse, with the data collector service, the second template to extract a second schema for the second scientific instrument. The electronic processor is further configured to query, with the data collector service, the second scientific instrument according to the second schema. The electronic processor is further configured to receive data from the second scientific instrument responsive to the query. The electronic processor is further configured to transmit, with a data relay agent, the data from the second scientific instrument to a remote data service according to the second schema.

Example 7 may include the subject matter of any of Examples 1-6, and may further specify that the electronic processor is configured to identify, in an electronic memory, a revised version of the template associated with the scientific instrument. The electronic processor is further configured to, responsive to identifying the revised version of the template, restart the data collector service. The electronic processor is further configured to parse, with the data collector service, the revised version of the template to extract a revised schema for the scientific instrument. The electronic processor is further configured to query, with the data collector service, the scientific instrument according to the revised schema. The electronic processor is further configured to receive additional data from the scientific instrument responsive to the query.

Example 8 may include the subject matter of any of Examples 1-7, and may further specify that the electronic processor is configured to retrieve the template from a pre-defined location in an electronic memory.

Example 9 may include the subject matter of any of Examples 1-8, and may further specify that the schema is associated with an instrument driver for the scientific instrument, and that the data collector service queries the scientific instrument via the instrument driver.

Example 10 may include the subject matter of any of Examples 1-9, and may further specify that the schema includes at least one selected from a group consisting of a data type, a data collection condition, a data collection schedule, a data filter, a data processing directive, and a data transmission schedule.

Example 11 is a method performed via a computing device for providing scientific instrument support system. The method includes retrieving, with a data collector service from a pre-defined location in an electronic memory, a template associated with a scientific instrument. The method further includes parsing, with the data collector service, the template to extract a schema for the scientific instrument. The method further includes querying, with the data collector service, an instrument driver for the scientific instrument according to the schema. The method further includes receiving, from the instrument driver, scientific instrument data responsive to the query.

Example 12 may include the subject matter of Example 11, and may further include transmitting the scientific instrument data to a remote data service according to the schema.

Example 13 may include the subject matter of Example 12, and may further include processing, with a data collector service, the scientific instrument data according to the schema to generate processed scientific instrument data. Example 13 may further specify that transmitting the data from the scientific instrument to the remote data service includes transmitting the processed data.

Example 14 may include the subject matter of Example 13, and may further specify that processing the data includes at least one selected from a group consisting of standardizing the data, aggregating the data, anonymizing the data, and contextualizing the data.

Example 15 may include the subject matter of any of Examples 12-14, and may further specify that transmitting the data from the scientific instrument to the remote data service includes transmitting the data from the scientific instrument according to a schedule defined by the schema.

Example 16 may include the subject matter of any of Examples 11-15, and may further include identifying, in an electronic memory with the data collector service, a second template associated with a second scientific instrument. The method further includes responsive to identifying the second template, restarting the data collector service. The method further includes parsing, with the data collector service, the second template to extract a second schema for the second scientific instrument. The method further includes querying, with the data collector service, the second scientific instrument according to the second schema. The method further includes receiving second scientific instrument data responsive to the query. The method further includes transmitting the second scientific instrument data to a remote data service according to the second schema, wherein the first schema and the second schema are different.

Example 17 may include the subject matter of any of Examples 11-16, and may further include identifying, in an electronic memory with the data collector service, a revised version of the template associated with the scientific instrument. The method further includes responsive to identifying the revised version of the template, restarting the data collector service. The method further includes parsing, with the data collector service, the revised version of the template to extract a revised schema for the scientific instrument. The method further includes querying, with the data collector service, the scientific instrument according to the revised schema. The method further includes receiving additional data from the scientific instrument responsive to the query.

Example 18 may include the subject matter of any of Examples 11-18, and may further specify that the schema includes at least one selected from a group consisting of a data type, a data collection condition, a data collection schedule, a data filter, a data processing directive, and a data transmission schedule.

Example 19 may include one or more non-transitory computer readable media having instructions thereon that, when executed by one or more processing devices of the scientific instrument support, cause the scientific instrument support to perform the subject matter of Example 11.

Example 20 may include a scientific instrument support apparatus. The scientific instrument support apparatus includes an electronic memory and a data collector logic. The data collector logic is configured to retrieve, from a pre-defined location in the electronic memory, a template associated with a scientific instrument. The data collector logic is further configured to parse the template to extract a schema for the scientific instrument. The data collector logic is further configured to query an instrument driver for the scientific instrument according to the schema. The data collector logic is further configured to receive, from instrument driver, scientific instrument data responsive to the query.

Example A includes any of the scientific instrument support modules disclosed herein.

Example B includes any of the methods disclosed herein.

Example C includes any of the scientific instrument support computing devices and systems disclosed herein.

1. A system for performing scientific instrument support, the system comprising:
an electronic computing device including an electronic processor, the electronic processor configured to:
parse, with a data collector service, a template associated with a scientific instrument to extract a schema for the scientific instrument;
query, with the data collector service, the scientific instrument according to the schema; and
receive data from the scientific instrument responsive to the query.

2. The system of claim 1, wherein the electronic processor is further configured to:
transmit, with a data relay agent, the data from the scientific instrument to a remote data service according to the schema.

3. The system of claim 2, wherein the electronic processor is further configured to:
process the data from the scientific instrument with the data collector service according to the schema to generate processed data,
wherein transmitting the data from the scientific instrument to the remote data service includes transmitting the processed data.

4. The system of claim 3, wherein processing the data includes at least one selected from a group consisting of standardizing the data, aggregating the data, anonymizing the data, and contextualizing the data.

5. The system of claim 4, wherein transmitting the data from the scientific instrument to the remote data service includes transmitting the data from the scientific instrument according to a schedule defined by the schema.

6. The system of claim 1, wherein the electronic processor is further configured to:
identify, in an electronic memory, a second template associated with a second scientific instrument;
responsive to identifying the second template, restart the data collector service;
parse, with the data collector service, the second template to extract a second schema for the second scientific instrument;
query, with the data collector service, the second scientific instrument according to the second schema;
receive data from the second scientific instrument responsive to the query; and
transmit, with a data relay agent, the data from the second scientific instrument to a remote data service according to the second schema.

7. The system of claim 1, wherein the electronic processor is further configured to:
identify, in an electronic memory, a revised version of the template associated with the scientific instrument;
responsive to identifying the revised version of the template, restart the data collector service;
parse, with the data collector service, the revised version of the template to extract a revised schema for the scientific instrument;
query, with the data collector service, the scientific instrument according to the revised schema; and
receive additional data from the scientific instrument responsive to the query.

8. The system of claim 1, wherein the electronic processor is further configured to:
retrieve the template from a pre-defined location in an electronic memory.

9. The system of claim 1, wherein:
the schema is associated with an instrument driver for the scientific instrument; and
the data collector service queries the scientific instrument via the instrument driver.

10. The system of claim 1, wherein the schema includes at least one selected from a group consisting of a data type, a data collection condition, a data collection schedule, a data filter, a data processing directive, and a data transmission schedule.

11. An automated method performed via a computing device for providing scientific instrument support system, the method comprising:
retrieving, with a data collector service from a pre-defined location in an electronic memory, a template associated with a scientific instrument;
parsing, with the data collector service, the template to extract a schema for the scientific instrument;
querying, with the data collector service, an instrument driver for the scientific instrument according to the schema; and
receiving, from the instrument driver, scientific instrument data responsive to the query.

12. The method of claim 11, further comprising:
transmitting the scientific instrument data to a remote data service according to the schema.

13. The method of claim 12, further comprising:
processing, with a data collector service, the scientific instrument data according to the schema to generate processed scientific instrument data,
wherein transmitting the data from the scientific instrument to the remote data service includes transmitting the processed data.

14. The method of claim 13, wherein processing the data includes at least one selected from a group consisting of standardizing the data, aggregating the data, anonymizing the data, and contextualizing the data.

15. The method of claim 12, wherein transmitting the data from the scientific instrument to the remote data service includes transmitting the data from the scientific instrument according to a schedule defined by the schema.

16. The method of claim 11, further comprising:
identifying, in an electronic memory with the data collector service, a second template associated with a second scientific instrument;
responsive to identifying the second template, restarting the data collector service;
parsing, with the data collector service, the second template to extract a second schema for the second scientific instrument;
querying, with the data collector service, the second scientific instrument according to the second schema;
receiving second scientific instrument data responsive to the query; and
transmitting the second scientific instrument data to a remote data service according to the second schema, wherein the first schema and the second schema are different.

17. The method of claim 11, further comprising:
identifying, in an electronic memory with the data collector service, a revised version of the template associated with the scientific instrument;
responsive to identifying the revised version of the template, restarting the data collector service;
parsing, with the data collector service, the revised version of the template associated to extract a revised schema for the scientific instrument;
querying, with the data collector service, the scientific instrument according to the revised schema; and
receiving additional data from the scientific instrument responsive to the query.

18. The method of claim 11, wherein the schema includes at least one selected from a group consisting of a data type, a data collection condition, a data collection schedule, a data filter, a data processing directive, and a data transmission schedule.

19. One or more non-transitory computer readable media having instructions thereon that, when executed by one or more processing devices of a scientific instrument support apparatus, cause the scientific instrument support apparatus to perform the method of claim 11.

20. The method of claim 16, wherein no changes are made to the data collector service before or after it is restarted.

21. A scientific instrument support apparatus, comprising:
a data collector logic configured to:
retrieve, from a pre-defined location in an electronic memory, a template associated with a scientific instrument;
parse the template to extract a schema for the scientific instrument;
query an instrument driver for the scientific instrument according to the schema; and
receive, from instrument driver, scientific instrument data responsive to the query.
